(19) United States
(12) Patent Application Publication
(10) Pub. No.: US 2009/0298557 A1
(43) Pub. Date: Dec. 3, 2009

(54) PORTABLE ELECTRONIC DEVICE WITH ADJUSTABLE DISPLAY

(75) Inventor: CHIA-CHIA HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/327,943

(22) Filed: Dec. 4, 2008

(30) Foreign Application Priority Data
May 30, 2008 (CN) 200810301878.3

(51) Int. Cl. H04M 1/00

(52) U.S. Cl. 455/575.1

(57) ABSTRACT

A portable electronic device comprises a body member (10), a display module (20), and a display adjustment mechanism (30). The body member (10) defines a chamber (18) therein for accommodating the display module (20). The display adjustment mechanism (30) is pivotably connected with the body member (10) and the display module (20). The display adjustment mechanism (20) is configured for allowing the position of the display module to be adjusted relative to the position of the body member.

### BACKGROUND

1. Field of the Invention

The present invention relates to portable electronic devices, particularly to portable electronic devices with adjustable displays.

2. Description of Related Art

Portable electronic devices with displays, such as mobile phones and personal digital assistant (PDA) are widely used. Some portable electronic devices have brackets fixed on the casing, and the brackets can extend away from the casing allowing the portable electronic device to “sit” on the desk. Thus, users can have a comfortable view of the display.

However, such portable electronic device may be difficult to operate (e.g. dial numbers) when sitting at an angle. Also, the portable electronic device may easily fall from a table or desk

Therefore, there is room for improvement within the art.

### BRIEF DESCRIPTION OF THE DRAWINGS

Many aspects of the exemplary portable electronic device can be better understood with reference to the following drawings. These drawings are not necessarily drawn to scale, the emphasis instead being placed upon clearly illustrating the principles of the exemplary portable electronic device. Moreover, in the drawings like reference numerals designate corresponding parts throughout the several views. Wherever possible, the same reference numbers are used throughout the drawings to refer to the same or like elements of an embodiment.

FIG. 1 illustrates, in isometric view, a portable electronic device according to an exemplary embodiment.

FIG. 2 illustrates, in isometric view, the portable electronic device of FIG. 1 with a display module in an open position, showing one aspect.

FIG. 3 illustrates, in isometric view, the portable electronic device of FIG. 2, showing another aspect.

### DETAILED DESCRIPTION OF EMBODIMENTS

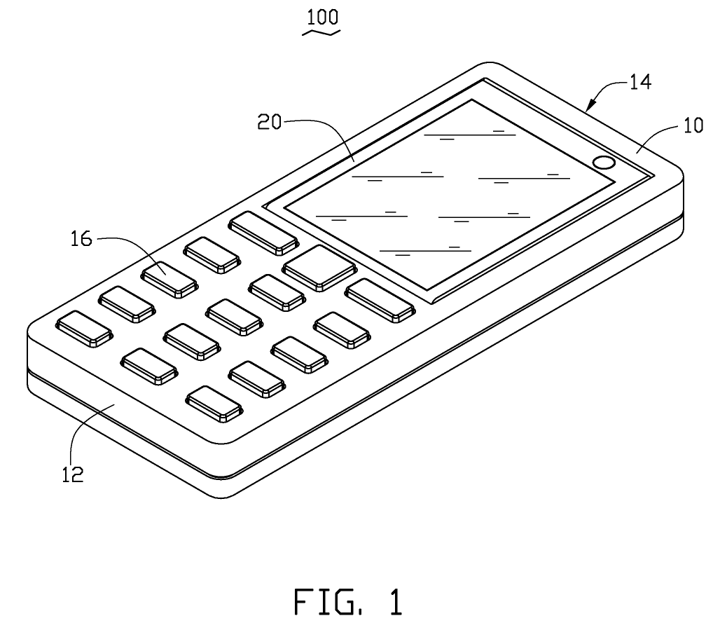

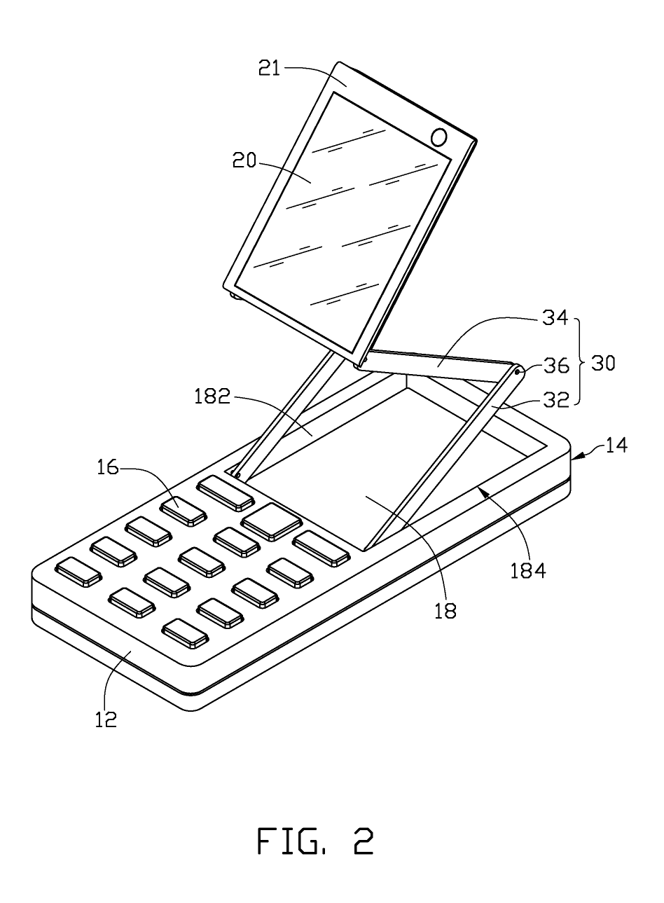

FIGS. 1 and 2 show a portable electronic device 100, such as a mobile phone, including a body member 10, a display module 20, and a display adjustment mechanism 30. The display adjustment mechanism 30 secures the display module 20 within the body member 10 (FIG. 1), and allows the display module 20 to be lifted from the body member 10 supported at an angle relative to the body member 10 (FIG. 2).

The body member 10 is generally rectangular including a first end 12 and an opposite second end 14. The body member 10 has a number of data input keys 16 positioned adjacent to the first end 12. The body member 10 defines a chamber 18 adjacent to the second end 14. A first sidewall 182 and an opposite second sidewall 184 are defined in the chamber 18. The chamber 18 can accommodate the display module 20.

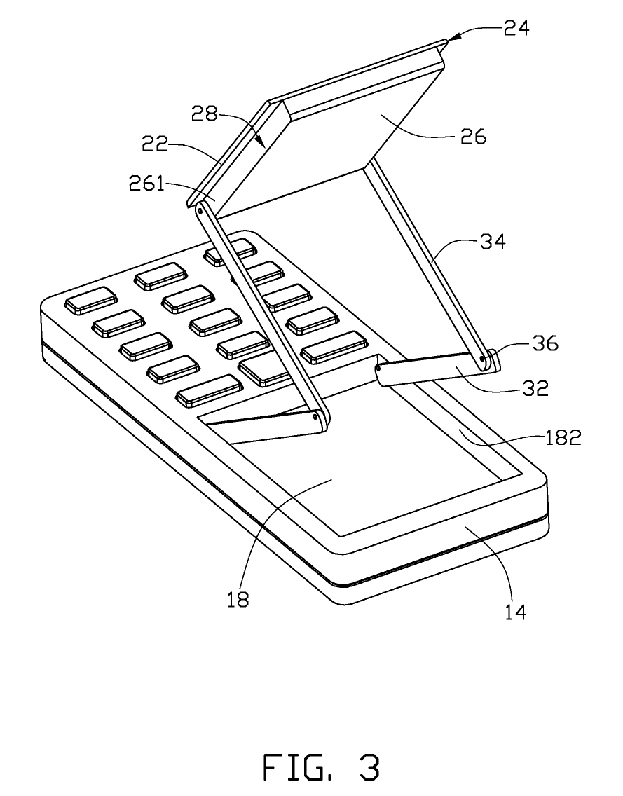

Referring to FIG. 3, the top panel 21 of the display module 20 is larger than an enclosure 26 for containing the circuitry of the display module 20. Therefore, side gaps 28 are formed between the edges 22 of top panel 21 and enclosure side wall 261. The side gaps 28 are for accommodating the display adjustment mechanism 30.

The display adjustment mechanism 30 includes two first brackets 32, two second brackets 34, and a number of pivotable fasteners, such as rivets 36. One end of each first bracket 32 pivotably connects with one end of each second brackets 34 by one rivet 36. The other end of each first bracket 32 pivotably connects with the corresponding sidewall of the chamber 18 by another rivet 36. The other end of each second bracket 34 pivotably connects with the corresponding enclosure side wall 261 by one rivet 36.

Referring to FIGS. 1 and 2, in use, the portable electronic device 100 is positioned on a flat surface e.g. desk (not shown). The display module 20 can be disengaged from the chamber 18 and lifted away from the body member 10. During this stage, the second brackets 34 pivot, relative to the first brackets 32, about the rivets 36 and out from the chamber 18. After that, the angle of the display module 20 relative to the body member 10 can be adjusted by pivoting the first brackets 32 about the rivets 36 and relative to the second brackets 34. When the display module 20 arrives at a desired angle, the rivets 36 secures the display module 20 at this angle.

The body member 10 can be stably positioned on the desk during adjusting the angle of the display module 20, thereby improving operability. In additional, the side gaps 28 receive the display adjustment mechanism 30 without affecting appearance of the portable electronic device 100. Appropriate counterweighting and springing (not shown) may also be used to assure the display module 10 stays in a lifted position against the pull of gravity and its own weight.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device, comprising:
a body member defining a chamber therein;
a display module for accommodation in the chamber; and
a display adjustment mechanism pivotably connected with the body member and the display module, the display adjustment mechanism configured for allowing the position of the display module to be adjusted relative to the position of the body member.

2. The portable electronic device as claimed in claim 1, wherein the display adjustment mechanism includes two first brackets and two second brackets, one end of each first bracket pivotably connects with one end of each second bracket, the other end of each first bracket pivotably connects to the body member, and the other end of each second bracket pivotably connects to the display module.

3. The portable electronic device as claimed in claim 2, wherein the display module has two side gaps and two side walls, the second brackets pivotably connects with the side walls, the first brackets and the second brackets being accommodated by the side gaps when the display module is accommodated in the chamber.

4. The portable electronic device as claimed in claim 2, wherein the body member has a first sidewall and a second sidewall located opposite to the first sidewall, the first sidewall and the second sidewall for defining the chamber, the first brackets pivotably connect with the first sidewall and the second sidewall.

5. The portable electronic device as claimed in claim 2, wherein the display adjustment mechanism includes a number of fasteners, the first brackets are pivotably connected with the body member and the second brackets by the fasteners.

6. A portable electronic device comprising:
a body member defining a chamber defined therein;
a display module for accommodation in the chamber; and
a display adjustment mechanism respectively pivotably connected with the body member and the display module, the display adjustment mechanism configured for biasing the display module from the chamber and supporting the display module on the body member.

7. The portable electronic device as claimed in claim 6, wherein the display adjustment mechanism includes two first brackets and two second brackets, one end of each first bracket pivotably connects with one end of each second brackets, the other end of each first bracket pivots to the base member, the other end of each second bracket pivots to the display module.

8. The portable electronic device as claimed in claim 7, wherein the display module has two symmetrical slots and two symmetrical bottom walls are formed on the display module, the second brackets pivotably connects with the bottom walls, the first brackets and the second brackets are received in the slots.

9. The portable electronic device as claimed in claim 7, wherein the body member has a first sidewall and a second sidewall located opposite to the first sidewall, the first sidewall and the second sidewall for defining the chamber, the first brackets pivotably connect with the first sidewall and the second sidewall.

10. The portable electronic device as claimed in claim 7, wherein the display adjustment mechanism includes a number of rivets, the first brackets respectively pivotably connected with the body member and the second brackets by means of the rivets.
